(19) United States
(12) Patent Application Publication
(10) Pub. No.: US 2004/0064712 A1
(43) Pub. Date: Apr. 1, 2004

(54) Systems and methods for protecting media content

(75) Inventors: William C. Arthur, Phoenix, AZ (US); Richard L. Maliszewski, Forest Grove, OR (US); Keith L. Shippy, Tempe, AZ (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/259,700

(22) Filed: Sep. 27, 2002

(51) Int. Cl. H04L 9/00

(52) U.S. Cl. 713/193

(57) ABSTRACT

An electronic system, such as a multimedia player, renders encrypted multimedia content from a local memory device or a remote multimedia server. In one embodiment, the multimedia player is implemented with a general-purpose computer executing tamper-resistant software (TRS). To prevent debugging of the TRS while it is executing, exception handlers that could be used by software debuggers or hackers are replaced by substitute exception handlers. Instrumented exceptions are occasionally caused by the TRS, and if these exceptions are not correctly handled by the substitute exception handlers, execution of the TRS may be terminated. To verify that the substitute (and non-substitute) exception handlers have not been tampered with by rogue software, the instructions of the exception handlers may be occasionally read and checked, and if any instruction has been changed, the TRS may be terminated. Various methods of protecting multimedia content are also described, in addition to a machine-accessible medium.

### TECHNICAL FIELD

Embodiments of the present invention relate generally to the protection of digital media and, more particularly, to systems and methods to provide improved tamper-resistant software (TRS) within media-rendering equipment.

### BACKGROUND INFORMATION

Media-rendering devices, such as televisions, DVD (digital video disc or digital versatile disc) players, MP3 (Moving Picture Experts Group, audio layer 3) players, and personal computers (PCs), are widely available. Such devices are capable of playing and rendering digital media files of many types, including video, audio, games, artwork, music compositions, scanned documents, software programs, still photographs, and the like. The term “multimedia”, as used herein, means media of any type that is recorded in any format.

Multimedia content often has high commercial value, and it is generally protected by intellectual property rights (IPRs), such as copyright, to safeguard its commercial value. A user of a media-rendering device must typically agree to the terms of a license, including payment of a license fee, in order to render a multimedia file (e.g. a video or sound-recording). However, to avoid the license fees and terms, people frequently download, copy, distribute, alter, and/or render multimedia files in violation of the IPRs and license terms applicable to such multimedia files.

In order to compel the use of multimedia content in accordance with the license terms, multimedia content may be distributed in an encrypted format. Software is often used to decrypt the multimedia content. The decryption process must be designed in such a way that the underlying algorithms and keys that are used cannot be easily reverse-engineered. Usage of the encrypted content by decrypting programs requires a key from the content licensor. A key may be any word, card, phrase, or other mechanism that is employed to access the encrypted multimedia content.

To prevent hackers from determining and learning keys, multimedia content distributors may employ tamper-resistant software (TRS) in their decrypting software. TRS uses code obfuscation techniques to prevent reverse engineering of decryption algorithms. However, even TRS may be vulnerable to determined hackers, who find ways to observe and modify the security features.

Making the protection of multimedia content more challenging is the fact that many multimedia content-rendering systems employ open and accessible architectures. Openness and accessiblity make such systems more commercially viable and more prevalent; however, these characteristics also render both the hardware and the software, including security-enhancing measures, more observable and modifiable by hackers.

In order to determine the key used by a decrypting program, hackers often use programming tools, such as software debuggers, to obtain the key from the program. A debugger allows a program to be stepped through one operation at a time. Debugging programs typically use exception or fault-handling mechanisms to implement single-stepping through code and the detection and processing of breakpoints.

Using a debugger, a hacker may step through the program execution, until one or more particular instructions are executed, or until a particular memory location stores a predetermined value or range of values. A debugger can show memory contents, such as the content of a memory location that stores a key.

Thus, the providers of multimedia content-rendering code often employ anti-debug techniques to prevent the code execution from being traced by software debuggers and similar tools.

However, in the seemingly never-ending war of wits between multimedia content providers and hackers, the latter occasionally overcome anti-debug techniques.

Thus, there is a need for improved ways to protect multimedia content from being reverse-engineered.

### BRIEF DESCRIPTION OF THE DRAWINGS

FIG. 1 is a block diagram of an exemplary electronic system to render multimedia content, in accordance with an embodiment of the present invention;

FIG. 2 is a block diagram of an exemplary multimedia server, in accordance with an embodiment of the present invention;

FIGS. 3A and 3B together constitute a flow diagram illustrating an exemplary method to prevent the execution of tamper-resistant software from within a debugger, in accordance with an embodiment of the present invention; and

FIG. 4 illustrates a state diagram of a method to verify that substitute and non-substitute exception handlers have not been tampered with, in accordance with an embodiment of the present invention.

### DETAILED DESCRIPTION OF EMBODIMENTS OF THE INVENTION

In the following detailed description of embodiments of the invention, reference is made to the accompanying drawings that form a part hereof, and in which is shown by way of illustration, but not of limitation, specific embodiments of the invention. These embodiments are described in sufficient detail to enable those skilled in the art to understand and implement them, and it is to be understood that other embodiments may be utilized and that mechanical, structural, electrical, functional, and procedural changes may be made without departing from the spirit and scope of the present disclosure. The following detailed description is, therefore, not to be taken in a limiting sense, and the scope of embodiments of the present invention is defined only by the appended claims.

In embodiments of the present invention, an electronic system, such as a multimedia player, renders encrypted multimedia content from a suitable source, such as a local memory device or a remote multimedia server. In one embodiment, the multimedia player is implemented with a general-purpose computer executing tamper-resistant software (TRS).

The term “multimedia content”, as used herein, includes multimedia data signals that are accessed from a multimedia source, and/or associated control signals (e.g. an Internet command).

To prevent debugging of executing TRS, exception handlers that could be used by software debuggers or hackers are replaced by substitute exception handlers. Instrumented (i.e. programmed) exceptions are occasionally caused by the TRS, and if these exceptions are not correctly handled by the substitute exception handlers, then execution of the TRS may crash or otherwise be terminated. To verify that the substitute exception handlers, as well as non-substitute exception handlers, have not been tampered with by rogue software, the instructions of the substitute and non-substitute exception handlers may occasionally be read and checked, and if any instruction has been changed, the TRS may be terminated.

The terms “exception”, “fault”, and “trap” are used interchangeably herein to mean an interrupt. An “exception handler” comprises instructions to process exceptions.

Various methods of protecting multimedia content are described herein. Also described herein are machine-accessible media containing instructions, which when accessed, result in a machine performing operations to protect multimedia content.

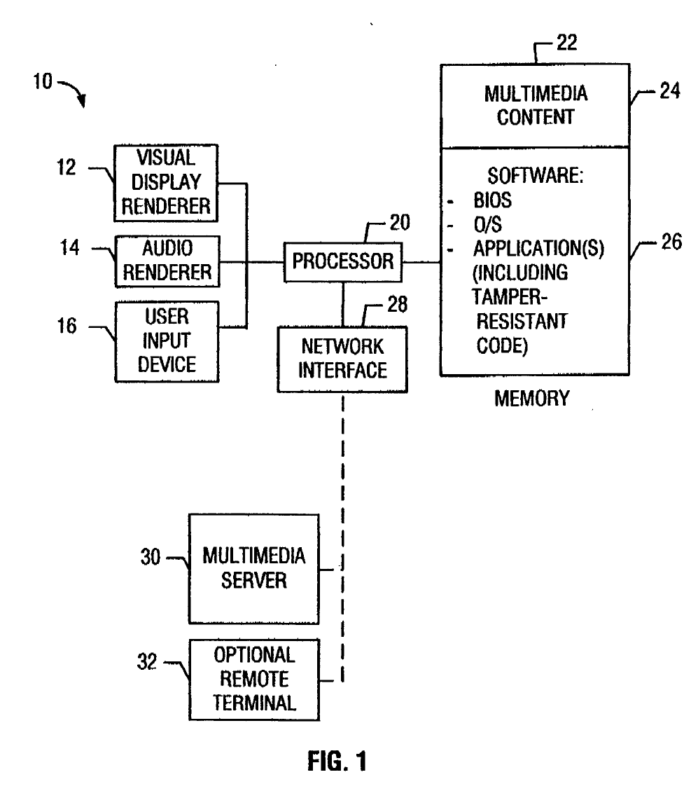

FIG. 1 is a block diagram of an exemplary electronic system 10 to render multimedia content, in accordance with an embodiment of the present invention.

The terms “play”, “render”, and “display”, as used herein, mean reproducing multimedia content in any one or more human-perceivable forms.

The block diagram of FIG. 1 represents just one exemplary embodiment of an electronic system 10 to render multimedia content. Electronic system 10 may be a home entertainment system. Alternatively, electronic system 10 may be any device or article that can render multimedia content. For example, such a device may take the form of a PC, an Internet appliance, a hand-held computer, a laptop computer, a wireless communications device (e.g., cellular phone, pager, etc.), a personal entertainment device (e.g. an MP3 device, a radio), audio-visual equipment, a personal digital assistant, an electronic book, and the like, without limitation.

Electronic system 10 comprises a suitable processor 20. In one embodiment, processor 20 is a Pentium® processor or an XScale™ processor available from Intel Corporation, Santa Clara, Calif.

The term “suitable”, as used herein, means having characteristics that are sufficient to produce the desired result(s). Suitability for the intended purpose can be determined by one of ordinary skill in the art using only routine experimentation.

The term “processor”, as used herein, means any type of computational circuit such as, but not limited to, a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), or any other type of processor, processing circuit, execution unit, or computational machine. The term also includes embedded controllers, such as Generic or Programmable Logic Devices or Arrays, Application Specific Integrated Circuits, single-chip computers, and the like.

Electronic system 10 further comprises a visual display renderer 12, which can include all suitable circuitry for converting multimedia content into humanperceivable visual form, and which is coupled to processor 20. In one embodiment, visual display renderer 12 may be a large-screen TV or high-definition TV. A sound reproduction element or audio renderer 14, which may include all suitable circuitry for converting multimedia content into human-perceivable audio form, is also coupled to processor 20. A suitable user input element or device 16, such as one or more control knobs, on-screen touch-sensitive buttons, keyboard, pointing device, joy stick, and/or the like may also be coupled to processor 20.

Electronic system 10 further comprises a suitable memory 22 to store, among other things, multimedia content 24 and software 26. Software 26 may include a basic input/output system (BIOS), an operating system (O/S), and one or more applications to render multimedia content. Such applications may include one or more programs (each comprising a plurality of instructions) for decrypting encrypted multimedia content. In embodiments of the present invention, the decrypting program(s) include tamper-resistant software (TRS). Software 26 may also include any other types of programs as required to perform the operational requirements of electronic system 10. In one embodiment, the O/S is the Linux™ operating system, which is available from a number of different sources. In other embodiments, a Windows™ O/S from Microsoft Inc., Redmond, Washington, may be used, such as Windows CE™, Windows 98™, WindowsNT™, or WindowsXp™.

Memory 22 may be implemented with any one or more suitable memory elements (not shown) such as, but not limited to, read only memory (ROM); random access memory (RAM); a hard drive; a removable media drive for handling compact disks (CDs), DVDs, diskettes, magnetic tape cartridges, memory cards, MemoryStick™ devices, SmartMedia™ devices; optical storage, chemical storage, biological storage, and/or other types of data storage; or the like.

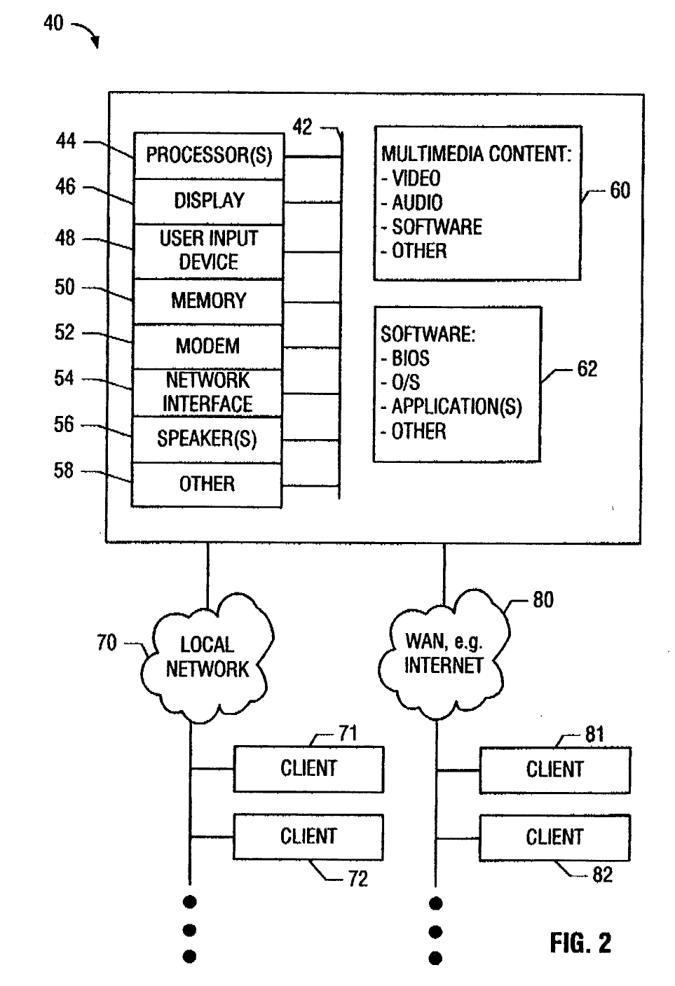

In some embodiments, electronic system 10 may comprise a suitable network interface 28. Network interface 28 is optional, and it may be included if electronic system 10 is to communicate with devices on a network. Such devices could be of any type. Examples of such devices include a multimedia server 30, an embodiment of which is illustrated in FIG. 2, and an optional remote terminal 32. Network interface 28 may couple electronic system 10 to any suitable communications medium, such as a cable, telephone line, wireless transmission (e.g. terrestrial or satellite receiver), or the like.

FIG. 2 is a block diagram of an exemplary multimedia server 40, in accordance with an embodiment of the present invention.

The block diagram of FIG. 2 represents just one exemplary embodiment of a multimedia server 40 to store multimedia content. Multimedia server 40 may be part of a dedicated home or in-building entertainment system. Alternatively, multimedia server 40 could be part of a local network 70 and/or a wide area network (WAN) 80 (e.g. the Internet). Multimedia server 40 may be any device that can store multimedia content.

In the embodiment shown in FIG. 2, multimedia server 40 comprises a system bus 42 to couple various components of the system. System bus 42 provides communications links among the various components of multimedia server 40 and may be implemented as a single bus, as a combination of busses, or in any other suitable manner. It will be understood by those of ordinary skill in the art that other embodiments of a multimedia server may include more or fewer elements than that illustrated in FIG. 2.

Coupled to bus 42 typically may be one or more processors 44, a screen or display 46, and a user input device 48 comprising one or more data entry or selection elements, such as a keyboard, mouse, trackball, joy stick, touch-sensitive screen, or the like.

Also coupled to bus 42 is a memory 50, which may be implemented with any one or more suitable memory elements (not shown) such as, but not limited to, those previously mentioned above regarding memory 22.

Additional elements may also be coupled to bus 42 such as a modem 52, a network interface unit 54, one or more loudspeakers 56, and other suitable devices 58.

Multimedia server 40 may also include a plurality of types of multimedia content 60. For example, multimedia content 60 may include, but is not limited to, video media, audio media, computer software, and other content, such as described earlier herein.

Multimedia server 40 may also include a plurality of types of software programs. For example, multimedia server 40 may comprise software 62 that includes a BIOS, O/S software, one or more software applications, and any other types of software as required to perform the operational requirements of multimedia server 40.

Multimedia server 40 may operate in a networked environment using physical and/or logical connections to local network 70 and/or WAN 80. The connections to these networks may be wired and/or wireless.

Local network 70 may comprise any number or type of devices, such as client devices 71 and 72. In one embodiment, client devices 71 and 72 may be similar or identical to electronic system 10 (FIG. 1).

WAN 80 may be any type of network that is greater in scope than local network 70. In one embodiment, WAN 80 comprises a global communications network, such as the Internet, to which any number of devices, such as client devices 81 and 82 may be coupled. In another embodiment, WAN 80 could comprise an intranet. In one embodiment, client devices 81 and 82 may be similar or identical to electronic system 10 (FIG. 1).

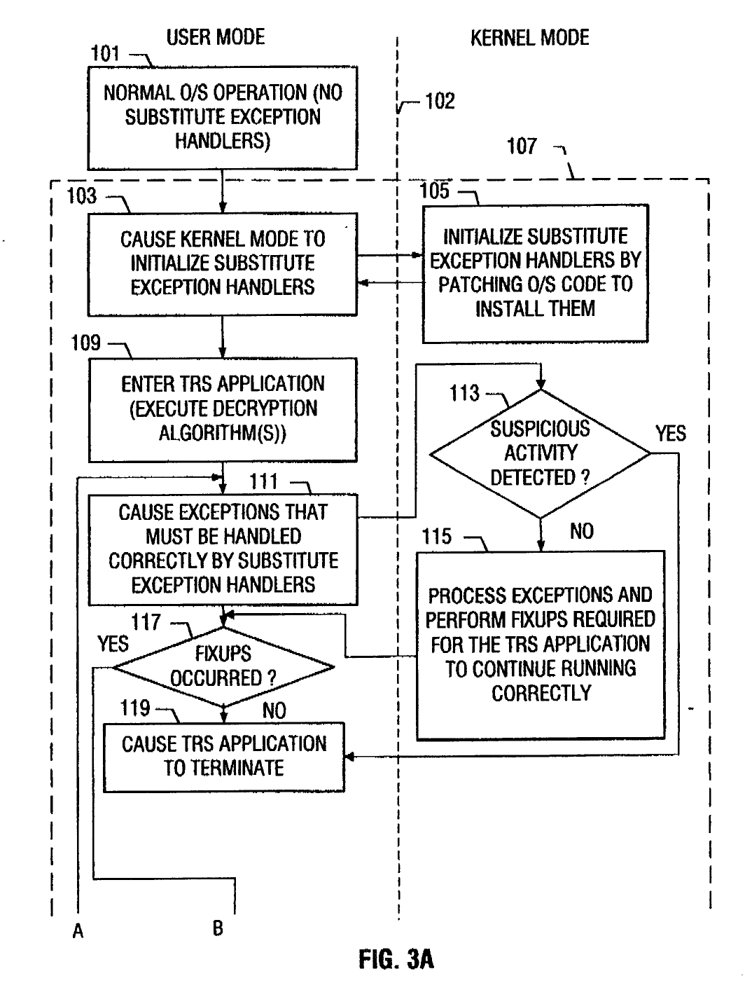

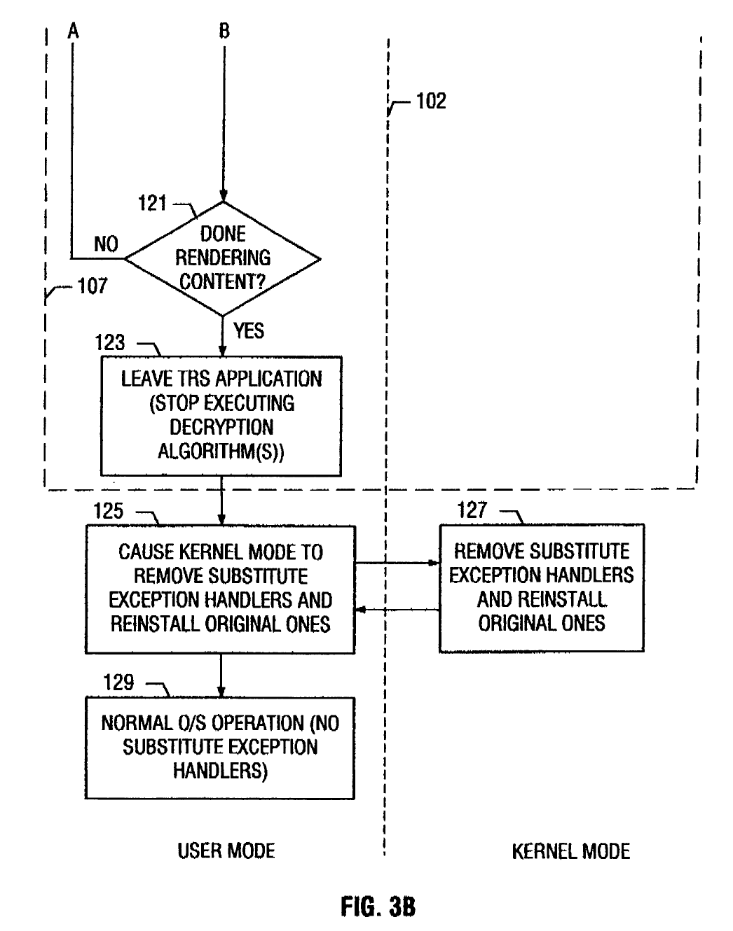

FIGS. 3A and 3B together constitute a flow diagram illustrating an exemplary method to prevent the execution of tamper-resistant software (TRS) from within a debugger, in accordance with an embodiment of the present invention. In FIGS. 3A-3B, the TRS is assumed to be part of an application that is rendering multimedia content. Such an application could be executed on any suitable media-rendering equipment, such as the electronic system 10 shown in FIG. 1, which is assumed to be an open architecture system.

In the embodiment illustrated in FIGS. 3A-3B, the execution of TRS from within a debugger is prevented by substituting new exception handlers or fault handlers for ones that could be used by software debuggers or hackers. This operation prevents software-debugging activities by hackers.

To prevent a determined hacker from defeating this operation by removing the substitute exception handlers and reinstalling the original ones, the proper execution of TRS is made dependent upon the presence of the substitute exception handlers.

In one embodiment, the TRS periodically causes instrumented exceptions that must be properly handled by the substitute exception handlers in order for the TRS to continue functioning correctly. This creates a dependency chain that reinforces the security of the system. Namely, substitute exception handlers prevent debuggers from running, and proper execution of the TRS is dependent upon the presence of the substitute exception handlers.

In one embodiment, as another security measure, the substitute and non-substitute exception handlers may be occasionally (e.g. periodically or randomly) analyzed to check whether any components or instructions have been tampered with and, if so, execution of the TRS may be immediately terminated, thus preventing further access to and/or rendering of the protected multimedia content.

The above-described operations and security measures will now be described regarding FIGS. 3A-3B. In the embodiment described, operations on the left-hand side of dashed line 102 in FIGS. 3A-3B may be performed in user mode, and those on the right-hand side of dashed line 102 may be performed in kernel mode. Those of ordinary skill in the art will understand that other implementations and organizations of computational operations may be carried out, depending upon the nature of the software (e.g. operating system, application, etc.) being used.

In 101, the electronic system is operating normally, and it is executing O/S instructions and instructions of one or more applications other than those of a tamper-resistant multimedia content-rendering application. In other words, no substitute exception handlers are currently in use. In one embodiment, a breakpoint (e.g. INT-3) substitute exception handler may be in use at this time, because it is used to initialize the other substitute exception handlers.

The box defined by 107, which comprises 103-123, encompasses the operations carried out by the substitute exception handlers to inhibit debugging attempts, according to one embodiment.

In 103, the electronic system prepares to begin executing a tamper-resistant multimedia content-rendering application that comprises the substitute exception handlers of an embodiment of the invention. A user mode instruction, via a breakpoint (e.g. INT-3) exception, instructs a kernel mode construct to initialize the substitute exception handlers.

The anti-debug operations of embodiments of the present invention may be implemented in any suitable way by those of ordinary skill in the art. In one embodiment, in which a Linux™ operating system is executing on a Pentium processor, substitute exception handlers are used to replace the exception handlers for INT-0 (divide-by-zero interrupt), INT-3 (break point interrupt), INT-1 (debug exception), and INT-14 (page fault interrupt). In other embodiments, alternative or additional O/S exception handlers may be replaced and/or deactivated. In yet a further embodiment, suitable modifications may be made to an interrupt descriptor table (IDT) to point to substitute exception handlers and/or to inactivate the standard O/S exception handlers.

In 105, a kernel mode construct initializes the substitute exception handlers by patching them into the O/S code.

In 109, the tamper-resistant multimedia content-rendering application is entered. This application executes one or more decryption algorithms to decrypt encrypted multimedia content. The application executes decryption instructions of the decryption algorithm(s) during this period, and the decrypted multimedia content can be rendered or otherwise accessed (e.g. copied).

In 111, instrumented exceptions that must be correctly handled by the substitute exception handlers are occasionally (e.g. periodically or randomly) caused. The instrumented exceptions may be caused, for example, by suitable exception-causing instructions within the tamper-resistant application. The number of exceptions may be controlled so as not to adversely affect application performance.

In 113, a check for any suspicious activity may be made. Any suitable mechanism may be used to make this determination, such as a kernel mode driver. Suspicious activity may include the detection of a debugger, an in-circuit emulator, a monitoring tool, a rogue exception handler, or the presence of any other type of sniffer, analyzer, or other unknown or unauthorized element. If any suspicious activity is detected, the process goes to 119; if no suspicious activity is detected, the process continues to 115.

In 115, the exceptions caused in 111 are processed, and any required fixups or other operations that are necessary for the tamper-resistant application to continue running correctly are performed. From 1 15, the process goes to 117.

In 117, whether fixups occurred or not implicitly determines whether the TRS continues to execute correctly. If the fixups occurred, the process continues to 121; otherwise, it goes to 119.

In 119, the tamper-resistant application may be terminated, e.g. by crashing. Further access to and/or rendering of multimedia content may be stopped. In one embodiment, any rogue debugging element or exception handler is rendered inoperative.

In 121, a determination is made whether the tamper-resistant application has finished rendering the multimedia content. If so, the method proceeds to 123;

otherwise, it returns to 111, whereupon one or more additional exceptions may occasionally be caused.

In 123, execution of the tamper-resistant multimedia content-rendering application, including the decryption algorithm(s), is stopped.

In 125, a user mode instruction instructs a kernel mode construct to remove the substitute exception handlers and to install the original ones.

In 127, the kernel mode construct removes the substitute exception handlers and reinstalls the original ones.

In 129, the electronic system returns to normal O/S operation, executing non-TRS that does not contain substitute exception handlers. In one embodiment, the electronic system does not fully return to normal operation, in that one or more of the standard O/S exception handlers are permanently replaced by one or more substitute exception handlers, e.g. by booting the electronic system from ROM-based software that contains the substitute exception handlers, that modifies the interrupt descriptor table (IDT), or by a device driver that installs one of the substitute exception handlers (for instance the INT-3 handler).

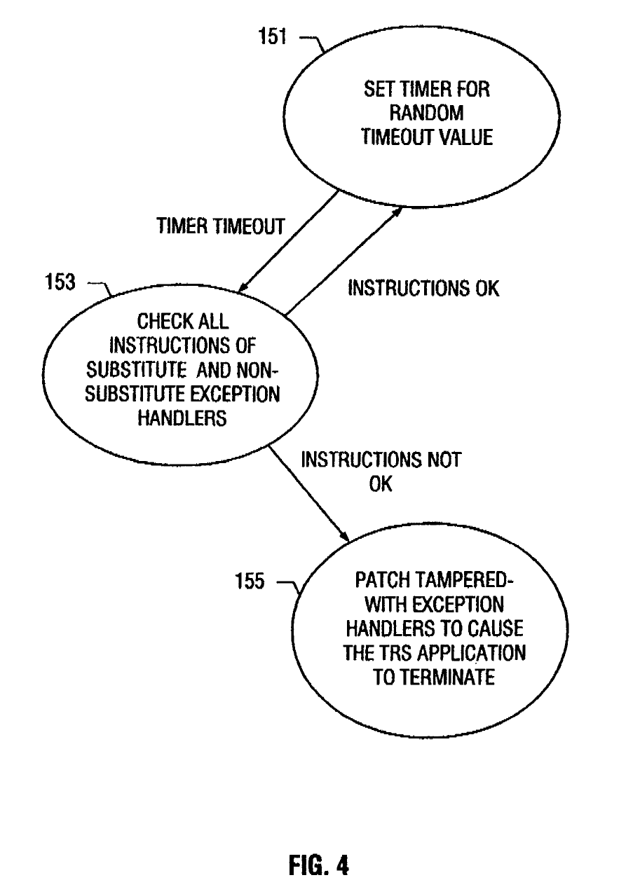

FIG. 4 illustrates a state diagram of a method to verify that substitute and non-substitute exception handlers have not been tampered with, in accordance with an embodiment of the present invention.

As mentioned earlier, in one embodiment, as another security measure (which in one embodiment is carried out while the tamper-resistant code is executing), the substitute and non-substitute exception handlers may be occasionally (e.g. periodically or randomly) analyzed to check whether any components or instructions have been tampered with, e.g. by rogue software, and, if so, execution of the tamper-resistant code may be immediately terminated, thus preventing further access to and/or rendering of the protected multimedia content.

This additional security measure will now be described regarding the operating states and activities shown in FIG. 4.

In 151, a kernel mode timer or random event generator may generate a random timeout value. The timer timeout is sent to 153.

In 153, in response to the timeout signal received from 151, a kernel mode software component may check some or all of the instructions of the substitute exception handlers and/or of non-substitute exception handlers, and it may determine whether all of these instructions are correct and have not been modified or otherwise tampered with, e.g. by rogue software. The presence of a rogue debugging element or exception handler would be detected. If the instructions are still OK, an OK signal is sent to 151, and execution of the tamper-resistant code continues normally. If the instructions are not OK, a corresponding signal is sent to 155.

In 155, the tamper-resistant code may be terminated. In one embodiment, some changes may be patched into the tampered-with substitute or non-substitute exception handlers or into the interrupt descriptor table (IDT), causing the tamper-resistant code to quickly terminate, e.g. because the tampered-with substitute or non-substitute exception handlers cannot correctly handle the exceptions that are generated (e.g. in 111, FIG. 3A) and perform the required fixups (e.g. in 113, FIG. 3A). In one embodiment, any rogue debugging element or exception handler may be rendered inoperative.

The operations described above with respect to the methods illustrated in FIGS. 3 and 4 can be performed in a different order from those described herein.

Embodiments of the present invention enable security-enhancing features of multimedia content to be protected from analysis and avoidance. Thus, the value of distributed multimedia content can be protected.

Embodiments of the invention may be readily implemented in a variety of machine platforms and operating systems. Embodiments of the invention may also provide enhanced security from attacks initiated from virtual operating systems.

In addition, new types of security attacks using debuggers that employ different exceptions, traps, and/or interrupts to handle single-stepping and breakpoints may be accommodated by embodiments of the invention. Because exceptions, traps, and interrupts represent the only interface between kernel mode and user mode in most operating systems, controlling this interface for the purpose of anti-debug capability is an effective defense against security attacks.

As shown herein, the present invention may be implemented in a number of different embodiments, including various methods, apparatus, and articles comprising machine-accessible media having associated instructions. Other embodiments will be readily apparent to those of ordinary skill in the art. The elements, algorithms, and sequence of operations may all be varied to suit particular requirements.

Embodiments of the invention may be implemented in conjunction with program modules, including functions, constructs, procedures, data structures, application programs, etc. for performing tasks, or defining abstract data types or low-level hardware contexts. Program modules, including instructions, may be stored in memory 22 (FIG. 1) and associated storage media of any type, including those mentioned earlier. Program modules may be delivered over transmission environments, including networks 70 and 80 (FIG. 1), in the form of packets, serial data, parallel data, propagated signals, or any other suitable form. Program modules may be used in a compressed or encrypted format, and they may be used in a distributed environment and stored in local and/or remote memory, for access by single and multi-processor machines, or any other type of electronic system 10 (FIG. 1).

In view of the disclosure herein, it will be apparent to those skilled in the art how to write suitable software routines that implement the functions, features, and operations discussed above.

The illustrated architecture of the electronic system and the multimedia server described herein are only examples of possible architectures. Embodiments of the present invention are in no way limited to any particular architecture for the electronic system and multimedia server.

FIGS. 1 and 2 are merely representational and are not drawn to scale. Certain proportions thereof may be exaggerated, while others may be minimized. FIGS. 1-4 illustrate various embodiments of the invention that can be understood and appropriately carried out by those of ordinary skill in the art.

Although specific embodiments have been illustrated and described herein, it will be appreciated by those of ordinary skill in the art that any arrangement or process that is calculated to achieve the same purpose may be substituted for the specific embodiments shown. This application covers any adaptations or variations of embodiments of the present invention. Therefore, it is manifestly intended that embodiments of this invention be limited only by the claims and the equivalents thereof.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

What is claimed is:

1. An apparatus comprising:
a storage medium having stored therein a plurality of decryption instructions, a plurality of exception handler instructions, and a plurality of exception-causing instructions; and
an execution unit coupled to the storage medium, the execution unit capable of executing at least one of the plurality of exception handler instructions in response to at least one of the plurality of exception-causing instructions.

2. The apparatus recited in claim 1, wherein the execution unit is to execute the at least one of the plurality of exception handler instructions, in response to the at least one of the plurality of exception-causing instructions, only during a period when the execution unit is to execute decryption instructions.

3. The apparatus recited in claim 1, wherein the execution unit is to determine whether execution of the at least one of the plurality of exception handler instructions is to be performed and, if not, the execution unit is to terminate execution of the decryption instructions.

4. The apparatus recited in claim 1, wherein the execution unit is to determine whether execution of the at least one of the plurality of exception handler instructions is to be performed and, if so, the execution unit executes the at least one of the plurality of exception handler instructions, performs one or more fixups, and continues to execute the decryption instructions.

5. The apparatus recited in claim 1, wherein the execution unit is to check whether any of the plurality of exception handler instructions have been tampered with and, if so, the execution unit is to terminate execution of the decryption instructions.

6. The apparatus recited in claim 1, wherein the execution unit is to check at random times whether any of the plurality of exception handler instructions have been tampered with and, if so, the execution unit is to terminate execution of the decryption instructions.

7. A method comprising:
executing at least one decryption instruction; and
executing at least one exception handler instruction, in response to at least one exception-causing instruction, while the at least one decryption instruction is executing.

8. The method of claim 7, further comprising:
determining whether execution of the at least one exception handler instruction should be performed correctly and, if not, terminating execution of the at least one decryption instruction.

9. The method of claim 8, wherein terminating execution of the at least one decryption instruction comprises failing to perform at least one fixup.

10. The method of claim 7, further comprising:
determining whether execution of the at least one exception handler instruction should be performed correctly and, if so, continuing execution of the at least one decryption instruction.

11. The method of claim 10, wherein continuing execution of the at least one decryption instruction comprises performing at least one fixup.

12. The method of claim 7, further comprising:
determining whether the at least one exception handler instruction has been tampered with and, if so, terminating execution of the at least one decryption instruction.

13. The method of claim 12, wherein determining is performed at random times.

14. The method of claim 7, further comprising:
determining whether the at least one exception handler instruction has been tampered with and, if so, patching a change into the at least one decryption instruction to cause execution of the at least one decryption instruction to terminate.

15. The method of claim 7, further comprising:
determining whether the at least one exception handler instruction has been tampered with and, if not, continuing execution of the at least one decryption instruction.

16. A method comprising:
executing a decryption algorithm to decrypt media content; and
preventing the decryption algorithm from being debugged.

17. The method of claim 16, wherein preventing renders a rogue debugging element inoperative.

18. The method of claim 16, wherein preventing renders a rogue exception handler inoperative.

19. The method of claim 16, wherein preventing includes executing a substitute exception handler.

20. The method of claim 19, further comprising:
causing an instrumented exception; and
determining whether the instrumented exception is correctly handled and, if not, terminating the execution of the decryption algorithm.

21. The method of claim 19, further comprising:
causing an instrumented exception; and
determining whether the instrumented exception should be correctly handled and, if so, correctly handling the instrumented exception, performing one or more fixups, and continuing execution of the decryption algorithm.

22. The method of claim 16, wherein preventing includes modifying an interrupt descriptor table.

23. An article comprising a machine-accessible medium having associated instructions, wherein the instructions, when accessed, result in a machine performing:
executing a plurality of decryption instructions; and
executing at least one of a plurality of exception handler instructions, in response to at least one of a plurality of exception-causing instructions, while the plurality of decryption instructions are executing.

24. The article recited in claim 23 wherein the instructions, when accessed, result in a machine further performing:
determining whether execution of the at least one of the plurality of exception handler instructions should be performed correctly and, if not, terminating execution of the plurality of decryption instructions.

25. The article recited in claim 24 wherein the instructions, when accessed, result in a machine further performing:
if terminating, then failing to perform at least one fixup.

26. The article recited in claim 23 wherein the instructions, when accessed, result in a machine further performing:
determining whether execution of the at least one of the plurality of exception handler instructions should be performed correctly and, if so, continuing execution of the plurality of decryption instructions.

27. The article recited in claim 26 wherein the instructions, when accessed, result in a machine further performing:
if continuing, then performing at least one fixup.

28. The article recited in claim 23 wherein the instructions, when accessed, result in a machine further performing:
determining whether any exception handler instruction has been tampered with and, if so, terminating execution of the plurality of decryption instructions.

29. The article recited in claim 23 wherein the instructions, when accessed, result in a machine further performing:
determining, at random times, whether any exception handler instruction has been tampered with and, if so, terminating execution of the plurality of decryption instructions.

30. The article recited in claim 23 wherein the instructions, when accessed, result in a machine further performing:
determining whether any exception handler instruction has been tampered with and, if so, patching a change into the plurality of decryption instructions to cause execution of the plurality of decryption instructions to terminate.

31. The article recited in claim 23 wherein the instructions, when accessed, result in a machine further performing:
determining whether any exception handler instruction has been tampered with and, if not, continuing execution of the decryption instructions.

32. An article comprising a machine-accessible medium having associated instructions, wherein the instructions, when accessed, result in a machine performing:
executing a plurality of decryption instructions; and
detecting when a rogue exception handler is operating.

33. The article recited in claim 32 wherein, in detecting, at least one of a plurality of exception handler instructions is executed in response to at least one instrumented exception.

34. The article recited in claim 33 wherein, in detecting, a determination is made whether the at least one of the plurality of exception handler instructions should be executed correctly and, if not, the instructions, when accessed, result in a machine further performing:
terminating execution of the plurality of decryption instructions.

35. The article recited in claim 33 wherein, in detecting, a determination is made whether the at least one of the plurality of exception handler instructions should be executed correctly and, if so, the instructions, when accessed, result in a machine further performing:
continuing execution of the plurality of decryption instructions.

36. The article recited in claim 33 wherein, in detecting, a determination is made whether any exception handler instruction has been tampered with and, if so, the instructions, when accessed, result in a machine further performing:
terminating execution of the plurality of decryption instructions.
